(19) United States
(12) Patent Application Publication
(10) Pub. No.: US 2017/0255179 A1
(43) Pub. Date: Sep. 7, 2017

(54) METHOD FOR MONITORING THE FUNCTIONAL CAPABILITY OF A DEVICE SYSTEM WITH A POWER TOOL AND A REMOTE CONTROL

(71) Applicant: Hilti Aktiengesellschaft, Schaan (LI)

(72) Inventor: Wilfried Kaneider, Rankweil (AT)

(73) Assignee: Hilti Aktiengesellschaft, Schaan (LI)

(21) Appl. No.: 15/509,175

(22) PCT Filed: Sep. 2, 2015
(86) PCT No.: PCT/EP2015/070033

§ 371 Date: Mar. 6, 2017

(30) Foreign Application Priority Data
Sep. 8, 2014 (EP) 14003098.2

(51) Int. Cl. G05B 19/042

(52) U.S. Cl. CPC G05B 19/0428; G05B 2219/24003; G05B 2219/25274; G05B 2219/23431; G05B 2219/21102

(57) ABSTRACT

A method for monitoring the functional capability of a device system, which includes a power tool (12) and a remote control (13), during operation, including the following steps is provided: a safety-relevant control signal (41) is sent from a control element (35) of the remote control (13) to a first checking unit (34) of the remote control (13), the control signal (41) is arranged in a data packet (42) together with a security code (SC) by the first checking unit (34) and transmitted from the first checking unit (34) to a second checking unit (28) of the power tool (12) by means of a communication connection (36, 37), the transmitted security code (43) is taken from the data packet (42) and, upon request by a monitoring unit (44), forwarded to the monitoring unit (44) by the second checking unit (28), the transmitted security code (43) is compared with a comparison code (VC) by the monitoring unit (44), and the power tool (12) is switched into a safe state by the monitoring unit (44) if the transmitted security code (43) deviates from the comparison code (VC).

The present invention relates to a method for monitoring the functional capability of a device system with a power tool and a remote control during operation, as well as a device system for carrying out a method of this type.

### BACKGROUND

According to the Machinery Directive of the European Union, device systems which include a motor-driven feed unit need to have an emergency stop switch to place the power tool into a safe state within a stipulated time period in the event of a malfunction. The operation of device systems which include a motor-driven feed unit is more and more frequently being carried out via remote controls. The transmission of control signals and data between the remote control and the power tool takes place via wired and cable-bound communication links, which are referred to as communication cables, or via wireless and cableless communication links, for example via radio links. In device systems which permit a wireless and cableless communication, cable connections for a communication cable are also provided, since a wireless and cableless communication is not permitted in certain areas, such as in airports or hospitals.

The Machinery Directive requires a high reliability for the transmission of safety-relevant control signals, such as those for an emergency stop switch, which must be demonstrated by the device manufacturer during the device approval process. No additional verification is required if proven components are used, for which compliance with safety standards has been demonstrated. For example, special communication cables for device systems which include a motor-driven feed unit therefore have, in addition to one or multiple data lines, a certified control line for transmitting the emergency stop control signal.

### SUMMARY OF THE INVENTION

It is an object of the present invention to comply with the functional reliability required by the Machinery Directive in a device system which includes a power tool and a remote control which are connectable via a wireless and cableless communication link or via a communication cable without a certified control line.

The present invention provides a method for monitoring the functional capability of a device system during operation includes the following steps:

a safety-relevant control signal is sent from a control element of the remote control to a first checking unit of the remote control;
the control signal is placed in a data package, together with a security code, by the first checking unit and transmitted from the first checking unit to a second checking unit of the power tool via a communication link;
the transmitted security code is extracted from the data packet by the second checking unit and forwarded to a monitoring unit at the request of the monitoring unit;
the transmitted security code is compared with a comparison code by the monitoring unit; and
the power tool is switched into a safe state by the monitoring unit if the transmitted security code deviates from the comparison code.

The advantage of the method according to the present invention for monitoring the functional capability of a device system during operation is that the functional reliability is implemented with the aid of hardware components, and no certification of software is required. The power tool is switched into a safe state by the monitoring unit if the transmitted security code deviates from the comparison code, the cause of the malfunction not being an issue. Possible causes may be malfunctions in the first checking unit, which incorrectly or incompletely stores the security code in the data packet, malfunctions in the communication link, which modifies or fails to transmit the security code, or malfunctions in the second checking unit, which modifies the security code or does not transmit it to the monitoring unit. The functional reliability may be set via the length of the security code which is stored in the first checking unit; the longer the security code, the higher the functional reliability.

A request to forward the security code to the monitoring unit is preferably transmitted by the monitoring unit to the second checking unit at a preset frequency. The monitoring unit is the controlling component for monitoring. The security code transmitted to the second checking unit is forwarded from the second checking unit to the monitoring unit only upon request. The only task of the second checking unit is to forward the transmitted security code; neither a processing nor a storage action is performed by the second checking unit.

The power tool is particularly preferably switched into a safe state by the monitoring unit if the transmitted security code was not completely forwarded to the monitoring unit within a preset time period after the request. In addition to the character sequence of the security code, the time required for transmission is an important influencing variable for the functional reliability. Upon actuating the emergency stop switch, the power tool may be placed in a safe state within the predefined time period only if the transmission times are short enough.

In one preferred refinement of the method, the control signals are placed in the data packet, together with a first security code and a second security code, by the first checking unit and transmitted to the second checking unit via the communication link. The functional reliability of the device system may be increased by using redundant systems. The functional reliability is increased by using two independent security codes. If the first and second security codes are stored in different areas of the remote control, the risk of both storage elements for the security codes being subjected to the same malfunction may be reduced.

Redundancy refers to the presence of functionally identical or comparable resources of a technical system, these resources not being required during malfunction-free operation. Resources may be, for example, redundant information, motors, assemblies, complete devices, control lines and power reserves. These additional resources are generally used to increase the general reliability, functional reliability and operating reliability.

The transmitted first and second security codes are removed from the data packet by the second checking unit, and the transmitted first security code is forwarded to a first monitoring unit upon the request of a first monitoring unit, and the transmitted second security code is forwarded to a second monitoring unit upon the request of a second monitoring unit. The first security code is compared with a first comparison code by the first monitoring unit, and the second security code is compared with a second comparison code by the second monitoring unit. The functional capability of the device system is independently checked twice. The first security code is checked by a first monitoring unit, and the second security code is checked by a second monitoring unit. The monitoring units compare the character sequence of the transmitted security code with the stored comparison code.

The power tool is switched into a safe state by the first and/or second monitoring unit(s) if the transmitted first security code deviates from the first comparison code, and/or if the transmitted second code deviates from the second comparison code. As soon as one of the two monitoring units detects a deviation between the transmitted security code and the comparison code, the power tool is placed into a safe state. The power tool continues to be operated only if both monitoring units do not detect a deviation.

In one refinement, a first request to forward the transmitted first security code to the first monitoring unit is transmitted by the first monitoring unit to the second checking unit at a first frequency, and a second request to forward the transmitted second security code to the second monitoring unit is transmitted by the second monitoring unit to the second checking unit at a second frequency. The power tool is switched into a safe state by the first and/or second monitoring unit(s) if the transmitted first security code was not completely forwarded to the first monitoring unit within a preset first time period after the request, and if the transmitted second security code was not completely forwarded to the second monitoring unit within a preset second time period after the request.

In addition to the character sequence of the security codes, the time required for transmission is an important influencing variable for the functional reliability. The power tool is switched into a safe state by the first and/or second monitoring unit(s) if the transmitted security codes were not completely forwarded to the monitoring units within a time period after the request. The frequencies at which the monitoring units send a request to the second checking unit may vary from each other, as may the time periods within which the transmitted security codes must be forwarded to the monitoring units. The power tool continues to be operated only if the transmitted security codes were forwarded to both monitoring units completely and without errors within the preset time periods.

To carry out the method according to the present invention, the device system includes a monitoring unit, which monitors the functional reliability of the device system during operation. According to the present invention, the first checking unit places the control signals of the control element, together with a security code, in a data packet and transmits them to the second checking unit via the communication link, and the monitoring unit compares the transmitted security code with a comparison code and checks it for deviations.

The monitoring unit preferably switches the device system into a safe state if the transmitted security code deviates from the comparison code.

In one preferred refinement, the device system includes a first monitoring unit, which monitors the functional capability of the device system during operation, and a second monitoring unit, which monitors the functional capability of the device system during operation, the first and second monitoring units having a redundant design.

The functional reliability may be increased by using redundant systems. A functional redundancy is aimed at providing safety-relevant systems with a multiple parallel design so that, if one component fails, the others continue operating. An additional spatial separation of the redundant systems may minimize the risk of the systems being subjected to a common malfunction. Using components from different manufacturers may avoid a systematic error causing multiple redundant systems to fail (diversified redundancy).

### BRIEF DESCRIPTION OF THE DRAWINGS

Exemplary embodiments of the present invention are described below on the basis of the drawing. The latter is not necessarily intended to represent the exemplary embodiments true to scale but rather the drawing is presented in a schematic and/or slightly distorted form where useful for the purpose of explanation. With regard to additions to the teachings directly apparent from the drawing, reference is hereby made to the relevant prior art. It should be taken into account that a variety of modifications and changes relating to the form and detail of a specific embodiment may be undertaken without deviating from the general idea of the present invention. The features of the present invention disclosed in the description, the drawing and the claims may be essential to the refinement of the present invention both individually and in any arbitrary combination. All combinations of at least two of the features disclosed in the description, the drawing, and/or the claims are also within the scope of the present invention. The general idea of the present invention is not limited to the exact form or the detail of the preferred specific embodiment illustrated and described below, nor is it limited to an object which would be limited in comparison to the object claimed in the claims. In given measurement ranges, values within the specified limits are also to be disclosed as limiting values and be able to be arbitrarily used and claimed. For the sake of simplicity, the same reference numerals are used below for identical or similar parts or for parts having identical or similar functions.

FIG. 1 shows a device system according to the present invention, which is designed as a wall sawing system, including a power tool, a remote control and a communication link between the power tool and the remote control;

FIG. 2 shows the interaction between the remote control and the power tool in the form of a block diagram, including a monitoring unit; and

FIG. 3 shows a refinement, including a first and a second monitoring unit.

### DETAILED DESCRIPTION

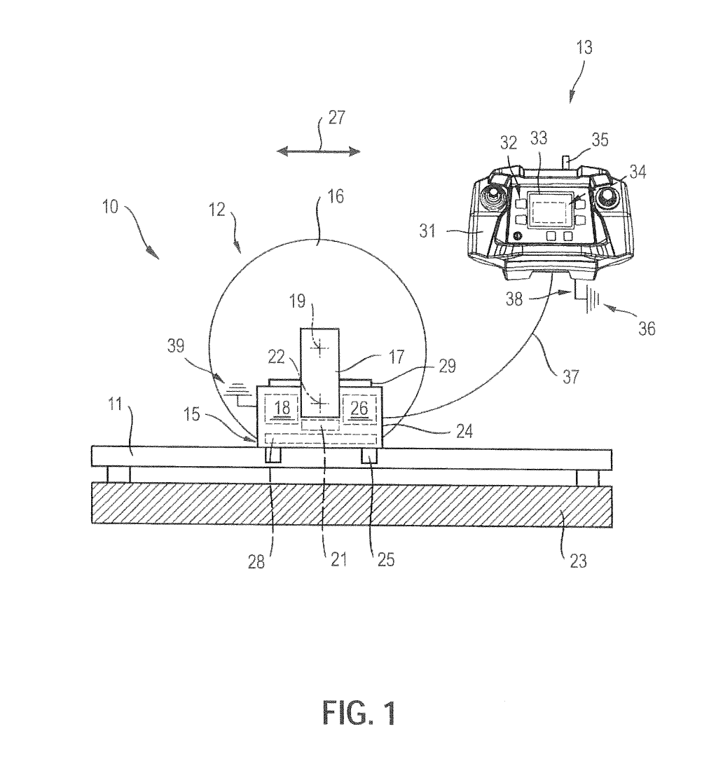

FIG. 1 shows a device system 10 according to the present invention, which is designed as a wall sawing system. Wall sawing system 10 includes a guide rail 11, a power tool 12, which is displaceably situated on guide rail 11, and a remote control 13. The power tool is designed as a wall saw 12 and includes a cutting unit 14 and a motor-driven feed unit 15. The cutting unit is designed as a saw head 14 and includes a cutting tool 16 designed as a saw blade, which is fastened to a saw arm 17 and is driven around a rotation axis 19 by a drive motor 18.

To protect the operator, saw blade 16 may be surrounded by a saw blade guard, which is fastened on saw arm 17 with the aid of a blade guard holder. Saw arm 17 is designed to be pivotable around a pivot axis 22 with the aid of a swing motor 21. The pivot angle of saw arm 17 determines, with the aid of a saw blade diameter of saw blade 16, how deep saw blade 16 dips into a workpiece 23 to be cut. Drive motor 18 and swing motor 21 are situated in a device housing 24. Motor-driven feed unit 15 includes a guide carriage 25 and a feed motor 26, which is also situated in device housing 24. Saw head 14 is fastened on guide carriage 25 and is designed to be displaceable by feed motor 26 along guide rail 11 in a feed direction 27. In addition to motors 19, 21, 25, a checking unit 28 for controlling saw head 14 and motor-driven feed unit 15 is also situated in device housing 24. At least one handle 29 is provided on device housing 24.

Remote control 13 includes a device housing 31, an input device 32, a display device 33 and a checking unit 34, which is situated in the interior of device housing 31. Checking unit 34 converts the inputs of input device 32 into control signals and data, which are transmitted to wall saw 12 via a communication link. In addition to input device 32, remote control 13 also includes a control element 35 designed as an emergency stop switch.

The communication link is designed as a wireless and cableless communication link 36 or as a communication cable 37. The wireless and cableless communication link is designed in the exemplary embodiment as a radio link 36, which forms between a first radio unit 38 on remote control 13 and a second radio unit 39 on power tool 12. Communication cable 37 is used, in particular, when a wireless and cableless communication is prohibited for safety reasons, for example in hospitals and airports, or when sources of interference hinder the wireless and cableless communication.

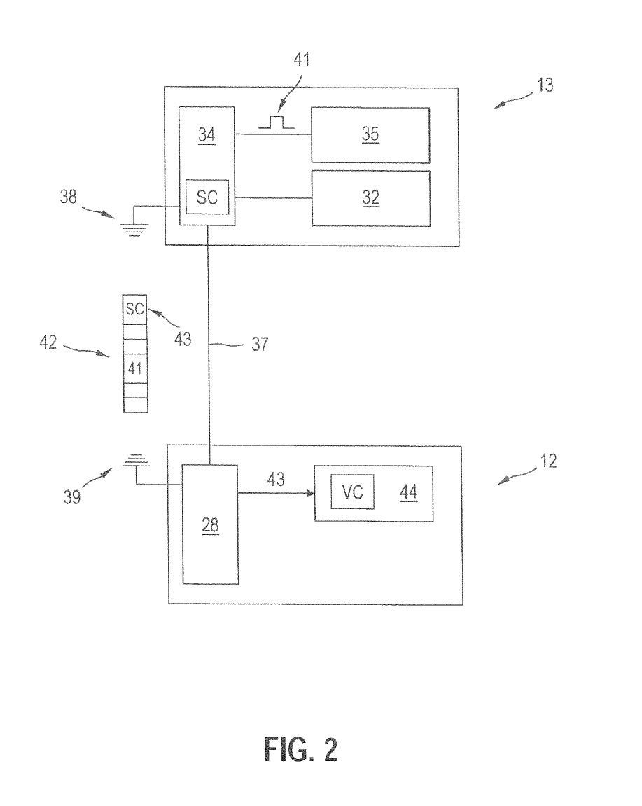

FIG. 2 shows the interaction between remote control 13 and power tool 12 in the form of a block diagram. In the exemplary embodiment in FIG. 1, checking unit 34 of remote control 13 is connected to checking unit 28 of power tool 12 via radio link 36 or via communication cable 37. To distinguish between checking units 28, 34, checking unit 34 of remote control 13 is referred to below as first checking unit 34, and checking unit 28 of power tool 12 is referred to as second checking unit 28.

Emergency stop switch 35 generates, at a frequency, a control signal 41 which is transmitted to first checking unit 34. Control signal 41 contains the information on the logical state (0 or 1) of emergency stop switch 35. State “0” corresponds to unactuated emergency stop switch 35, and state “1” corresponds to actuated emergency stop switch 35. Device system 10 may be safely operated only if it is ensured that control signal 41 is transmitted to second checking unit 28.

To check the functional capability of device system 10, a security code SC is stored in first checking unit 34, which is placed by first checking unit 34 in a data packet 42, together with control signal 41 of emergency stop switch 35 as well as control signals and data of input device 32. Data packet 42 is forwarded from first checking unit 34 to second checking unit 28 via communication link 36, 37. Second checking unit 28 does not recognize security code SC itself but rather recognizes the position and length of security code SC in data packet 42 and extracts this data section 43, together with the transmitted security code, from data packet 42.

Power tool 12 includes a monitoring unit 44, in which a comparison code VC is stored. Comparison code VC corresponds to security code SC, which is stored in first checking unit 34. A request to transmit data section 43, including the transmitted security code, to monitoring unit 44 within a predefined time period T is sent by monitoring unit 44 to second checking unit 28 at a preset interrogation frequency fₐ. Upon the expiry of time period T, monitoring unit 44 checks whether a data section 43 was transmitted. If a data section 43 was transmitted, monitoring unit 44 compares data section 43 with comparison code VC. If data section 43 deviates from comparison code VC, monitoring unit 44 decides that remote control 13 or communication link 36, 37 has a malfunction, and prompts that power tool 12 is to be switched into a safe state by second checking unit 28. In device systems such as wall sawing unit 10, which include an emergency stop switch, the safe state may be obtained, for example, by interrupting the power supply to motors 19, 21, 25.

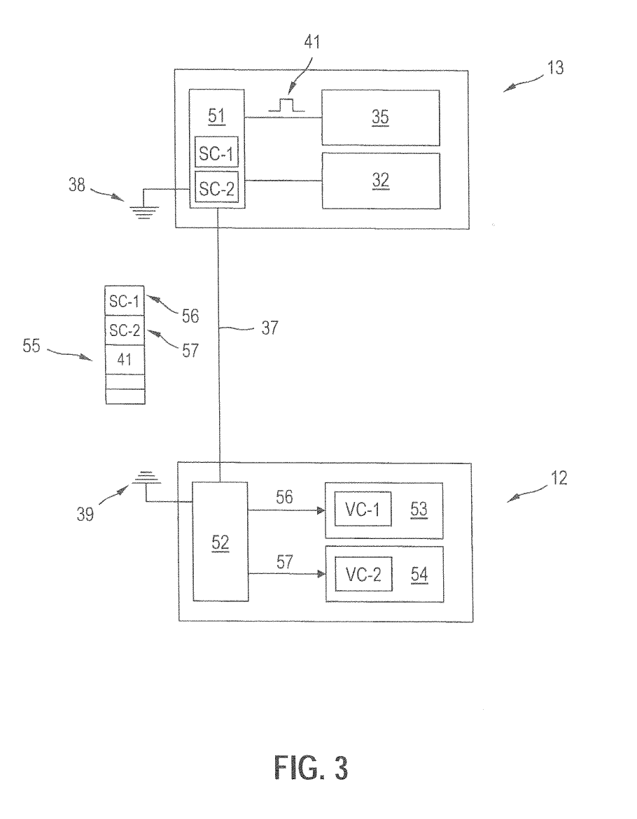

FIG. 3 shows a refinement of a device system 50 according to the present invention, which, like device system 10 in FIG. 1, is designed as a wall sawing system and includes guide rail 11, power tool 12 and remote control 13. Device system 50 differs from device system 10 with respect to the design of the checking units of power tool 12 and remote control 13. Remote control 13 includes a first checking unit 51, and power tool 12 includes a second checking unit 52, which are connectable via wireless and cableless communication link 36 or communication cable 37.

To increase the functional reliability of device system 50 during operation and to achieve a switchover of power tool 12 into a safe state in the event of a malfunction, second checking unit 52 includes a first monitoring unit 53 and a second monitoring unit 54, which have a redundant design and work independently of each other. First and second monitoring units 53, 54 correspond to the design of monitoring unit 44 of device system 10 and may replace monitoring unit 44. A first security code SC-1 and a second security code SC-2 are stored in first checking unit 51. The functional reliability of the device system may be set via the length of security codes SC-1, SC-2, which are stored in first checking unit 51; the longer the security codes SC-1, SC-2, the higher the functional reliability.

Emergency stop switch 35 generates, at a predefined frequency, control signal 41 which is transmitted to first checking unit 51. Control signal 41 is placed in a data packet 55 by first checking unit 51, together with first security code SC-1 and second security code SC-2, first security code SC-1 being stored in a first preset position in data packet 55, and second security code SC-2 being stored in a second preset position. Data packet 55 is transmitted from first checking unit 51 to second checking unit 52 via communication link 36, 37.

First and second security codes SC-1, SC-2 are unknown to second checking unit 52. Second checking unit 52 recognizes the first position and length of first security code SC-1 in data packet 55 as well as the second position and length of second security code SC-2 in data packet 55. The corresponding data sections, including the security codes, are extracted from the data packet by second checking unit 52 and forwarded to first and second monitoring units 53, 54 on request. The data section including first security code SC-1 is referred to as first data section 56, and the data section including second security code SC-2 is referred to as second data section 57.

A first request to forward first data section 56 to first monitoring unit 53 is transmitted by first monitoring unit 53 to second checking unit 52 at a first frequency f₁. First monitoring unit 53 compares first data section 56 with a first comparison code VC-1, which is stored in first monitoring unit 53. If first data section 56 deviates from stored first comparison code VC-1, first monitoring unit 53 prompts that power tool 12 is to be switched into a safe state. If first data section 56 matches stored first comparison code VC-1, first monitoring unit 53 checks whether first security code SC-1 was completely forwarded to first monitoring unit 53 within a preset first time period T₁ after the request. If first security code SC-1 was not completely forwarded to first monitoring unit 53 within first time period T₁ after the request, power tool 12 is switched into a safe state. If first security code SC-1 was completely forwarded to first monitoring unit 53 within first time period T₁, the check by first monitoring unit 53 is concluded.

A second request to forward second data section 57 to second monitoring unit 54 is transmitted by second monitoring unit 54 to second checking unit 52 at a second frequency f₂. Second monitoring unit 54 compares second data section 57 with a second comparison code VC-2, which is stored in second monitoring unit 54. If second data section 57 deviates from stored second comparison code VC-2, second monitoring unit 54 prompts that power tool 12 is to be switched into a safe state. If second data section 57 matches stored second comparison code VC-2, second monitoring unit 54 checks whether second security code SC-2 was completely forwarded to second monitoring unit 54 within a preset second time period T₂ after the request. If second security code SC-2 was not completely forwarded to second monitoring unit 54 within second time period T₂, power tool 12 is switched into a safe state. If second security code SC-2 was completely forwarded to second monitoring unit 54 within second time period T₂, the check by second monitoring unit 54 is concluded.

1. A method for monitoring the functional capability of a device system (10; 50), which includes a power tool (12) and a remote control (13), during operation, including the following steps:
a safety-relevant control signal (41) is sent from a control element (35) of the remote control (13) to a first checking unit (34; 51) of the remote control (13);
the control signal (41) is placed in a data packet (42; 55), together with a security code (SC; SC-1, SC-2), by the first checking unit (34; 51) and transmitted from the first checking unit (34; 51) to a second checking unit (28; 52) of the power tool (12) via a communication link (36, 37);
the transmitted security code (43; 56, 57) is extracted from the data packet (42; 55) by the second checking unit (28; 52) and forwarded to a monitoring unit (44; 53, 54) upon the request of the monitoring unit (44; 53, 54);
the transmitted security code (43; 56, 57) is compared with a comparison code (VC; VC-1, VC-2) by the monitoring unit (44; 53, 54); and
the power tool (12) is switched into a safe state by the monitoring unit (44; 53, 54) if the transmitted security code (43; 56, 57) deviates from the comparison code (VC; VC-1, VC-2).

2. The method as recited in claim 1,
characterized in that a request to forward the security code (43; 56, 57) to the monitoring unit (44; 53, 54) is transmitted from the monitoring unit (44; 53, 54) to the second checking unit (28; 52) at a preset frequency (f; f₁, f₂).

3. The method as recited in claim 2,
characterized in that the power tool (12) is switched into a safe state by the monitoring unit (44; 53, 54) if the transmitted security code (SC) was not completely forwarded to the monitoring unit (44; 53, 54) within a preset time period (T) after the request.

4. The method as recited in claim 1,
characterized in that the control signals are placed in the data packet (55), together with a first security code (SC-1) and a second security code (SC-2), by the first checking unit (51) and transmitted to the second checking unit (52) via the communication link (36, 37).

5. The method as recited in claim 4,
characterized in that the transmitted first and second security codes (56, 57) are extracted from the data packet (55) by the second checking unit (52), and the transmitted first security code (56) is forwarded to a first monitoring unit (53) at the request of the first monitoring unit (53), and the transmitted second security code (57) is transmitted to a second monitoring unit (54) at the request of the second monitoring unit (54).

6. The method as recited in claim 5,
characterized in that the transmitted first security code (56) is compared with a first comparison code (VC-1) by the first monitoring unit (53), and the transmitted second security code (57) is compared with a second comparison code (VC-2) by the second monitoring unit (54).

7. The method as recited in claim 6,
characterized in that the power tool (12) is switched into a safe state by the first and/or second monitoring unit(s) (53, 54) if the transmitted first security code (56) deviates from the first comparison code (VC-1), and/or if the transmitted second security code (57) deviates from the second comparison code (VC-2).

8. The method as recited in one of claims 5 through 7,
characterized in that a first request to forward the transmitted first security code (56) to the first monitoring unit (53) is transmitted by first monitoring unit (53) to the second checking unit (52) at a first frequency (f₁), and a second request to forward the transmitted second security code (57) to the second monitoring unit (54) is transmitted by the second monitoring unit (54) to the second checking unit (52) at a second frequency (f₂).

9. The method as recited in claim 8,
characterized in that the power tool (12) is switched into a safe state by the first and/or second monitoring unit(s) (53, 54) if the transmitted first security code (56) was not completely forwarded to the first monitoring unit (53) within a preset first time period (T₁) after the request, and/or if the transmitted second security code (57) was not completely forwarded to the second monitoring unit (54) within a preset second time period (T₂) after the request.

10. A device system (10; 50) for carrying out a method as recited in one of claims 1 through 9, including:
a remote control (13), which includes a safety-relevant control element (35), an input device (32) and a first checking unit (34; 51), which converts the inputs of the input device (32) into control signals and data;
a power tool (12), which includes a cutting tool (16), a drive motor (18), which drives the cutting tool (16), and a second checking unit (28; 52), which controls the power tool (12);
a communication link (36, 37), via which the first checking unit (34; 51) of the remote control (13) is connectable to the second checking unit (28; 52) of the power tool (12); and
a monitoring unit (44; 53, 54), which monitors the functional capability of the device system (10; 50) during operation,
characterized in that the first checking unit (34; 51) places the control signal (41) of the safety-relevant control element (35), together with a security code (SC; SC-1, SC-2), in a data packet (42, 55) and transmits it to the second checking unit (28; 52) via the communication link (36, 37), and the monitoring unit (44; 53, 54) compares the transmitted security code (43; 56, 57) with a comparison code (VC; VC-1, VC-2) and checks it for deviations.

11. The device system as recited in claim 10,
characterized in that the monitoring unit switches the device system (10; 50) into a safe state if the transmitted security code (43; 56, 57) deviates from the comparison code (VC; VC-1, VC-2).

12. The device system as recited in one of claims 10 through 11,
characterized in that the device system (50) includes a first monitoring unit (53), which monitors the functional capability of the device system (50) during operation, and a second monitoring unit (54), which monitors the functional capability of the device system (50) during operation, the first and second monitoring units (53, 54) having a redundant design.
